(19) United States
(12) Patent Application Publication
(10) Pub. No.: US 2013/0083229 A1
(43) Pub. Date: Apr. 4, 2013

(54) EMI SHIELD FOR CAMERA MODULE

(71) Applicants: Wei-Feng Lin, Hsinchu (TW); Chen-Wei Tsai, Xinfu (TW)

(72) Inventors: Wei-Feng Lin, Hsinchu (TW); Chen-Wei Tsai, Xinfu (TW)

(73) Assignee: OMNIVISION TECHNOLOGIES, INC., Santa Clara, CA (US)

(21) Appl. No.: 13/250,916

(22) Filed: Sep. 30, 2011

(51) Int. Cl. H04N 9/07; H04N 5/225

(52) U.S. Cl. 348/336; 348/373; 348/340; 348/E09.003; 348/E05.028

(57) ABSTRACT

Embodiments of the invention describe an electro-magnetic interference (EMI) shield cover disposed over a wafer level camera module. Said camera module includes substrate having a plurality of imaging pixels, an imaging lens unit disposed on a top side the substrate and a plurality of conductive connectors disposed a bottom side of the substrate, wherein at least one of the conductive connectors comprises a ground connector. The substrate further includes a thru-silicon via (TSV) accessible on the top-side of the substrate and communicatively coupled to the ground connector. The EMI shield is communicatively coupled to the TSV, and thus coupled to the ground connection of the digital camera module.

This disclosure relates generally to camera modules, and more particularly, but not exclusively, relates to digital camera modules with integrated electromagnetic interference (EMI) protection.

### BACKGROUND INFORMATION

Mobile electronic devices with image capture abilities, such as cellular telephones, are becoming increasingly popular. The technology used to manufacture image sensors, and in particular complementary metal-oxide-semiconductor (CMOS) and charge-coupled device (CCD) image sensors, has continued to advance at a great pace. The demands for higher resolution, lower power consumption, and smaller devices have encouraged the further miniaturization and integration of the image sensor and the other associated elements needed to construct a digital camera module.

Many digital camera modules require protection from electromagnetic interference (EMI) that might occur when the camera is installed near other electronic components. FIG. 1 is an illustration of a prior art camera module. Camera module 100 includes printed circuit board type substrate 101, image sensors arranged on substrate 102, glass cover plate 103 disposed on the image sensor, and lens holding assembly 104 positioned above the glass cover plate.

Metal supporting case 110 covers lens holding assembly 104 and image sensor substrate 102, and is soldered to ground connections of PCB substrate 101. The metal supporting case may provide EMI protection as well as shock protection. As shown, this type of independent shielding component becomes larger and heavier than the camera module itself. Also, the metal shielding case is typically manufactured through a combination of bending and pressing processes which limits the case shape to a rectangular column that entirely covers the camera module. This is an inappropriate solution for a small, thin, light-weight portable device.

### BRIEF DESCRIPTION OF THE DRAWINGS

Non-limiting and non-exhaustive embodiments of the disclosure are described with reference to the following figures, wherein like reference numerals refer to like parts throughout the various views unless otherwise specified.

FIG. 1 is an illustration of a prior art camera module.

FIG. 2 illustrates a digital camera module according to an embodiment of the disclosure.

FIG. 3 illustrates a cross-section view of digital camera module according to an embodiment of the disclosure.

FIG. 4 illustrates a digital camera assembly with integrated EMI shielding according to an embodiment of the disclosure.

FIG. 5 illustrates a digital camera assembly with integrated EMI shielding according to an embodiment of the disclosure.

FIG. 6 illustrates an imaging system according to an embodiment of the disclosure.

### DETAILED DESCRIPTION

Embodiments of a low height camera module with integrated electromagnetic interference (EMI) protection are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. The term “or” as used herein is normally meant to encompass a meaning of an inclusive function, such as “and/or.”

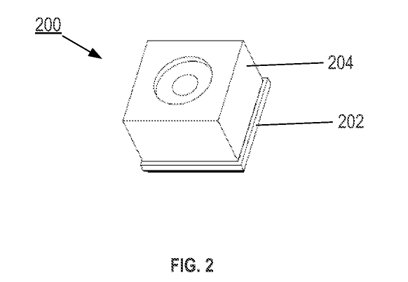

FIG. 2 illustrates a digital camera module according to an embodiment of the disclosure. Digital camera modules may be manufactured and assembled piece by piece, or with wafer-level camera (WLC) technology. In WLC technology many of the optical components may be manufactured on substrate wafers comprising silicon, glass or plastic. These opto-wafers are mounted together with a complementary metal-oxide-semiconductor (CMOS) image sensor wafer and then diced into individual camera modules. The complete camera, including the optics, may manufactured and packaged at the wafer level using available semiconductor technology. The WLC technology reduces manufacturing and packaging costs, and improves quality by replacing many manual operations with fully automatic wafer scale processing.

Wafer level camera module 200 includes sensor package 202, and lens assembly 204 (having one or more lenses) disposed on the top of the sensor package. In this embodiment, lens assembly 204 is of a cube shape. In other embodiments, lens assembly may comprise any shape (e.g., cylindrical, free-form, etc.) that fits over sensor package 202. The thickness of sensor package 202 may be less than the thickness of lens cube 204, but the width of sensor package 202 may be larger than the width of lens cube 204. In other embodiments, the widths of sensor package 202 and lens cube 204 may be identical. Furthermore, other size and shape combinations are possible.

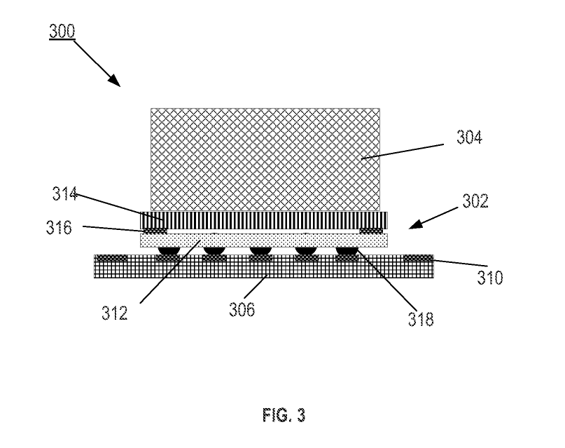

FIG. 3 illustrates a cross-section view of digital camera module according to an embodiment of the disclosure. Camera assembly 300 includes a lens cube 304, image sensor package 302, and printed circuit board (PCB) substrate 306. PCB 306 includes metal traces 310 disposed on its surface to connect image sensor package 302 to other circuit elements (e.g., circuitry to exchange data with other components of a host mobile phone or computer tablet device).

Sensor package 302 includes image sensor substrate 312, which may include a plurality of image sensors. In some embodiments, said plurality of image sensors may be a frontside illuminated (FSI) array of imaging pixels disposed within image sensor substrate 312, wherein each FSI imaging pixel includes a photodiode region for accumulating an image charge in response to light incident upon a frontside of the FSI array. In some embodiments, each of the FSI imaging pixels disposed within image sensor substrate 312 may also include a microlens disposed on a frontside of the image sensor substrate below the photodiode region and optically aligned to focus light received from the frontside onto the photodiode region, and a color filter disposed between the microlens and the photodiode region to filter the light received from the frontside.

In other embodiments, said plurality of image sensors may be a backside illuminated (BSI) array of imaging pixels disposed within image sensor substrate 312, wherein each BSI imaging pixel includes a photodiode region for accumulating an image charge in response to light incident upon a backside of the BSI array. In some embodiments, each of the BSI imaging pixels disposed within image sensor substrate 312 may also include a microlens disposed on a backside of the image sensor substrate below the photodiode region and optically aligned to focus light received from the backside onto the photodiode region, and a color filter disposed between the microlens and the photodiode region to filter the light received from the backside.

In this embodiment, cover glass 314 is disposed above image sensor substrate 312, secured by means of adhesive 316. Solder balls 318 connect image sensor substrate 312 both electrically and structurally to metal traces 310 of PCB 306. Solder balls 318 may be communicatively coupled to image sensor substrate 312 via various processes (e.g., using a reflow process, using a ball grid array arrangement, using flip chip technology, using bonding wires, and/or the like)

In some instances, when camera assembly 300 is subjected to EMI, such EMI may be transmitted to sensor package 302—specifically image sensor substrate 312, creating electrical noise which may result in image degradation. Embodiments of the invention provide small camera modules, such as camera module 300, with integrated EMI protection meeting the requirements of mobile applications.

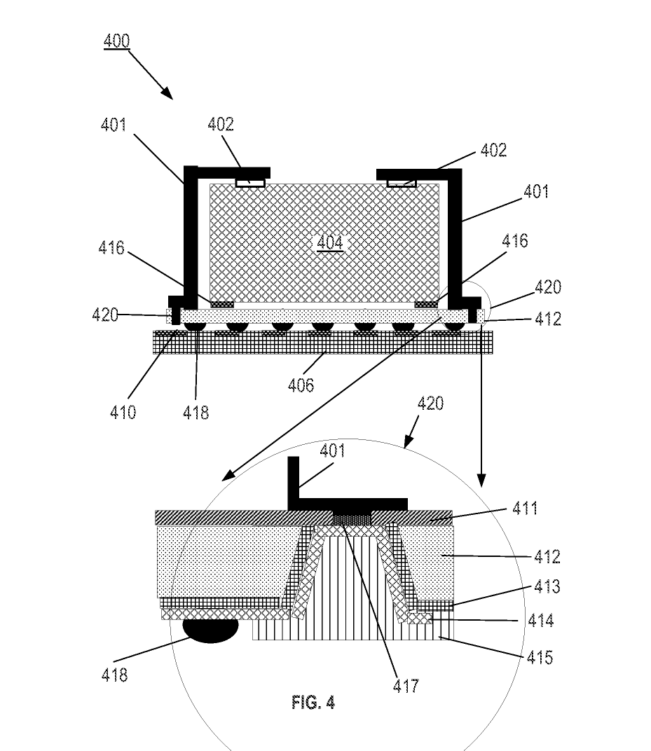

FIG. 4 illustrates a digital camera assembly with integrated EMI shielding according to an embodiment of the disclosure. Camera module 400 includes lens cube 404, image sensor substrate 412, and PCB substrate 406. Said PCB includes metal traces 410 disposed on its surface which are operable to connect image sensor substrate 412 through solder balls 418 to other system circuit elements.

Image sensor substrate 412 is directly secured to lens cube 404 by adhesive structure 416. Thus, instead of cover glass 314 as shown in FIG. 3, digital camera module 400 simply includes a minimal void separating lens cube 404 and image sensor substrate 412. In this embodiment, the absence of a cover glass provides for a low height for camera module 400.

To provide protection from EMI, protection enclosure 401 is secured to lens cube 404. Enclosure 400 is a can-type shield made of metal, and has no opening except one for light passing through such that no electro-magnetic field can penetrate the enclosure. In this embodiment, enclosure 401 has a top sheet element and four side walls. The side walls have no openings. The top sheet element has a central opening to allow light and images to pass into camera module 400.

EMI protection enclosure 401 may be secured to lens cube 404 by dispensing glue 402 on the top surface of lens cube 404, disposing enclosure 401 over lens cube 404 by surface-to-surface mating, and curing glue 402. Enclosure 401 may make electrical connection to metal traces 410 on a surface of PCB 406 through intermediate electrical feedthrough structure 420.

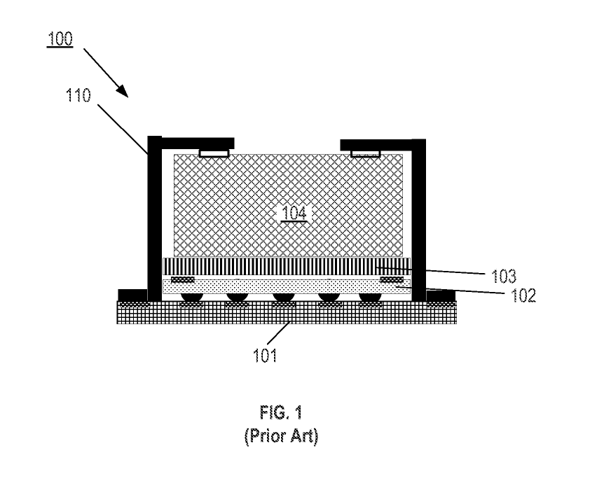

In this embodiment, rather than directly contacting PCB 406 as was shown in prior art camera module 100 of FIG. 1, protective enclosure 401 contacts the top surface of image sensor substrate 412 where metal landing pad 417 is formed. Electrical connection between enclosure 401 and pad 417 may be facilitated with a conductive adhesive which is not shown or other known methods of electrical connection.

FIG. 4 additionally illustrates an expanded view of feedthrough 420. The expanded view shows a hole or via formed through image sensor substrate 412 which is lined on its sides by insulator 413. Said via may be formed via a known chip scale packing (“CSP”) or thru-silicon via (“TSV”) process. Metal layer 414 is formed over insulator 413 and extends along the lower surface of substrate 412 to connect to solder ball 418. Metal layer 414 also connects to metal pad 417 which is in direct electrical contact with enclosure 401. Insulating layer 411 may surround metal pad 417 laterally along the top surface of substrate 412.

Structural integrity and electrical insulation may be facilitated by the formation of layer 415 which fills the via and may be composed of solder mask material or another convenient insulating material. The horizontal extension of enclosure 401 away from its vertical member along the top surface of substrate 410 may be modified at other locations and for example be removed at those locations to prevent unwanted electrical contact with feedthroughs (such as feedthrough 420) which may not be assigned for EMI protection. Such other feedthroughs may be assigned for example to power and signal functions required by the image sensor which may also utilize electrical connection to like assigned solder balls on the lower surface of substrate 402.

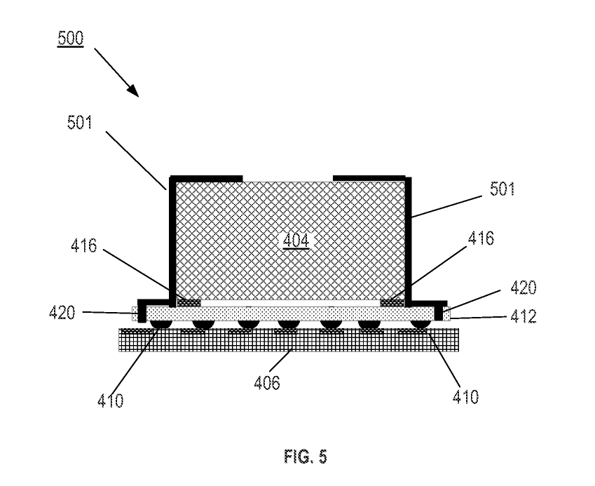

FIG. 5 illustrates a digital camera assembly with integrated EMI shielding according to an embodiment of the disclosure. Camera assembly 500 is similar to camera assembly 400 of FIG. 4, except that EMI protection is provided by EMI coating 501 which may be formed directly on the outer surfaces of lens cube 404, adhesive 416, and the upper surface of image sensor substrate 412, in particular on metal pad 417. Appropriate masking structures are placed, for example, over the lens opening at the top of lens cube 404 and upon metal pads similar to metal pad 417 which have been assigned to functions other than EMI protection, prior to the deposition of EMI coating 501. EMI coating 501 may be deposited by sputtering, or spray painting, or plating, or a number of other commonly known thin film deposition processes. The above described masking structures may be removed after the deposition of EMI coating 501.

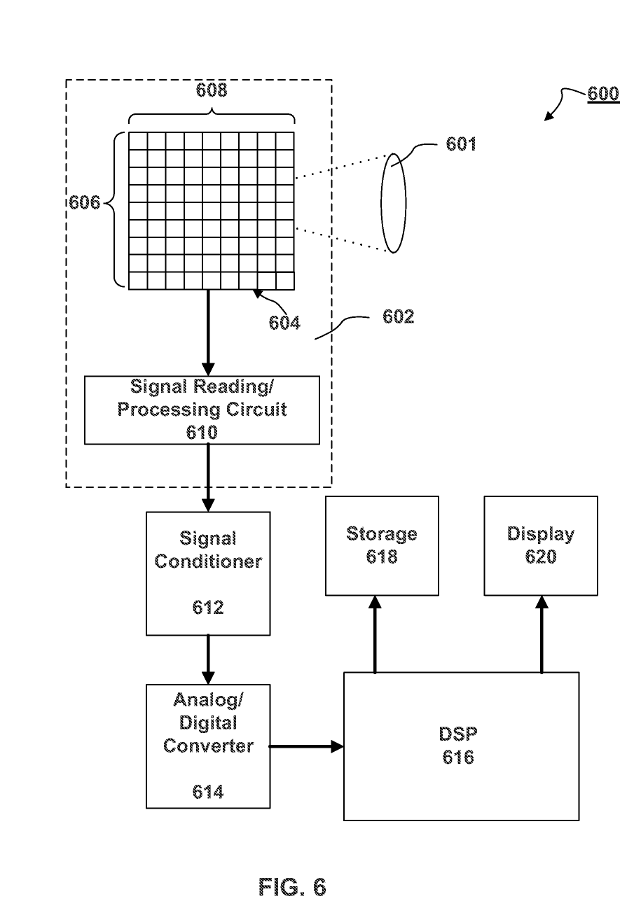

FIG. 6 illustrates an imaging system according to an embodiment of the disclosure. System 600 as illustrated includes optics 601, which can include refractive, diffractive or reflective optics or combinations of these, coupled to image sensor 602 to focus an image onto the pixels in pixel array 604 of the image sensor. Pixel array 604 captures the image and the remainder of imaging system 600 processes the pixel data from the image. Optics 601 and image sensor 602 may be protected from EMI interference via any of the above described embodiments of the invention.

Image sensor 602 comprises pixel array 604 and signal reading (i.e., readout) and processing circuit 610. In one embodiment, image sensor 602 is a BSI image sensor including a pixel array 604 that is two-dimensional and includes a plurality of pixels arranged in rows 606 and columns 608, but in other embodiments it could be an FSI image sensor or an image sensor that combines BSI with FSI.

During operation of pixel array 604 to capture an image, each pixel in pixel array 604 captures incident light (i.e., photons) during a certain exposure period and converts the collected photons into an electrical charge. The electrical charge generated by each pixel can be read out as an analog signal, and a characteristic of the analog signal such as its charge, voltage or current is representative of the intensity of light that was incident on the pixel during the exposure period.

Illustrated pixel array 604 is regularly shaped, but in other embodiments the array can have a regular or irregular arrangement different than shown and can include more or less pixels, rows, and columns than shown. Moreover, in different embodiments pixel array 604 can be a color image sensor including red, green, and blue pixels designed to capture images in the visible portion of the spectrum, or can be a black-and-white image sensor and/or an image sensor designed to capture images in the invisible portion of the spectrum, such as infra-red or ultraviolet.

Image sensor 602 includes signal reading and processing circuit 610. Among other things, circuit 610 can include circuitry and logic that methodically reads analog signals from each pixel, filters these signals, corrects for defective pixels, and so forth. In an embodiment where circuit 610 performs only some reading and processing functions, the remainder of the functions can be performed by one or more other components such as signal conditioner 612 or digital signal processor (DSP) 616. Although shown in the drawing as an element separate from pixel array 604, in some embodiments reading and processing circuit 610 can be integrated with pixel array 604 on the same substrate or can comprise circuitry and logic embedded within the pixel array. In other embodiments, however, reading and processing circuit 610 can be an element external to pixel array 604 as shown in the drawing. In still other embodiments, reading and processing circuit 610 can be an element not only external to pixel array 604, but also external to image sensor 602.

Signal conditioner 612 is communicatively coupled to image sensor 602 to receive and condition analog signals from pixel array 604 and reading and processing circuit 610. In different embodiments, signal conditioner 612 can include various components for conditioning analog signals. Examples of components that can be found in the signal conditioner include filters, amplifiers, offset circuits, automatic gain control, etc. In an embodiment where signal conditioner 612 includes only some of these elements and performs only some conditioning functions, the remaining functions can be performed by one or more other components such as circuit 610 or DSP 616. Analog-to-digital converter (ADC) 614 is communicatively coupled to signal conditioner 612 to receive conditioned analog signals corresponding to each pixel in pixel array 604 from signal conditioner 612 and convert these analog signals into digital values.

DSP 616 is communicatively coupled to analog-to-digital converter 614 to receive digitized pixel data from ADC 614 and process the digital data to produce a final digital image. DSP 616 can include a processor and an internal memory in which it can store and retrieve data. After the image is processed by DSP 616, it can be output to one or both of a storage unit 618 such as a flash memory or an optical or magnetic storage unit and a display unit 620 such as an LCD screen.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A camera module comprising:
a substrate including a plurality of imaging pixels;
an imaging lens unit disposed on a top side of the substrate;
a plurality of conductive connectors disposed on a bottom side of the substrate, wherein at least one of the conductive connectors comprises a ground connector;
a thru-silicon via (TSV) extending through the substrate and accessible from the top-side of the substrate and communicatively coupled to the ground connector on the bottom side; and
an electro-magnetic interference (EMI) shield cover disposed over the imaging lens unit and communicatively coupled to the TSV.

2. The camera module of claim 1, wherein the EMI shield cover comprises a metal can-type shield.

3. The camera module of claim 1, wherein the EMI shield cover comprises a metal coating layer deposited over the camera module.

4. The camera module of claim 3, wherein the metal coating layer comprises a metal layer deposited over the camera module via a sputter deposition process.

5. The camera module of claim 1, wherein the imaging lens unit comprises a lens cube.

6. The camera module of claim 1, wherein the plurality of conductive connectors comprises a plurality of solder balls.

7. The camera module of claim 1, further comprising:
a plurality of microlenses for each of the plurality of imaging pixels disposed on the substrate to focus light received onto the respective imaging pixel; and
a plurality of color filters for each of the plurality of imaging pixels disposed between the respective imaging pixel and its microlens to filter the light.

8. The camera module of claim 7, further comprising a void disposed between the plurality of microlenses and the lens unit.

9. The camera module of claim 1, wherein the plurality of imaging pixels comprises an array of frontside illuminated (FSI) imaging pixels.

10. The camera module of claim 1, wherein the plurality of imaging pixels comprises an array of backside illuminated (BSI) imaging pixels.

11. A system comprising:
a digital camera module including:
an image sensor substrate having a plurality of imaging pixels;
an imaging lens unit disposed on a top side of the image sensor substrate; and
a plurality of conductive connectors disposed on a bottom side of the image sensor substrate, wherein at least one of the conductive connectors comprises a ground connector;
a thru-silicon via (TSV) extending through the substrate and accessible from the top-side of the substrate and communicatively coupled to the ground connector on the bottom side;
an electro-magnetic interference (EMI) shield cover disposed over the digital camera module and coupled to the TSV of the image sensor substrate; and
a printed circuit board (PCB) substrate coupled to the plurality of conductive connectors to receive image data from the digital camera module.

12. The system of claim 11, wherein the EMI shield cover comprises a metal can-type shield.

13. The system of claim 11, wherein the EMI shield cover comprises a metal coating layer deposited over the wafer level camera module.

14. The system of claim 13, wherein the metal coating layer comprises a metal layer disposed over the wafer level camera module via a sputter deposition process.

15. The system of claim 11, wherein the imaging lens unit comprises a lens cube.

16. The system of claim 11, wherein the plurality of conductive connectors comprises a plurality of solder balls.

17. The system of claim 11, the digital camera module further comprising:
a plurality of microlenses for each of the plurality of imaging pixels disposed on the image sensor substrate to focus light received onto the respective imaging pixel; and
a plurality of color filters for each of the plurality of imaging pixels disposed between the respective imaging pixel and its microlens to filter the light.

18. The system of claim 17, the digital camera module further comprising a void disposed between the plurality of microlenses and the lens unit.

19. The system of claim 11, wherein the plurality of imaging pixels comprises an array of frontside illuminated (FSI) imaging pixels.

20. The system of claim 1, wherein the plurality of imaging pixels comprises an array of backside illuminated (BSI) imaging pixels.
